(19) United States
(12) Patent Application Publication
(10) Pub. No.: US 2025/0214814 A1
(43) Pub. Date: Jul. 3, 2025

(54) PNEUMATIC LIFTING GEAR AND METHOD FOR DETECTING AND RECORDING OPERATING STATUSES AND PARAMETERS OF A PNEUMATIC LIFTING GEAR

(71) Applicant: J.D. Neuhaus Holding GmbH & Co. KG, Witten (DE)

(72) Inventors: Piotr KRUPNIK, Iserlohn (DE); Simon BROSE, Hattingen (DE)

(21) Appl. No.: 18/841,663

(22) PCT Filed: Feb. 9, 2023
(86) PCT No.: PCT/EP2023/053244

§ 371 Date: Aug. 26, 2024

(30) Foreign Application Priority Data
Mar. 8, 2022 (DE) 10 2022 105 430.6

(51) Int. Cl. B66D 3/26; B66D 3/20

(52) U.S. Cl. CPC B66D 3/26; B66D 3/20

(57) ABSTRACT

The invention relates to a pneumatic hoist and a method for capturing and storing operating states and operating parameters of a pneumatic hoist. In order to provide a pneumatic hoist and a method for capturing and storing operating states and operating parameters of a pneumatic hoist, which allow operating states and operating parameters of the hoist to be reliably determined with a high degree of accuracy in a structurally simple manner, it is provided that the pneumatic hoist comprises a pneumatic motor for lifting and lowering a load, a first fluid inlet of the motor for lifting the load, a second fluid inlet of the motor for lowering the load and a fluid outlet exiting the motor, wherein at least one, preferably two pressure sensors are arranged in the region of the first and/or the second fluid inlet and at least one further pressure sensor is arranged in the region of the fluid outlet. Furthermore, the pneumatic hoist comprises a data processing unit which is designed to capture the pressure values of the pressure sensors and to calculate operating states and operating parameters of the hoist therefrom, and a load collective storage for storing the operating states and operating parameters of the hoist.

The invention relates to a pneumatic hoist and a method for capturing and storing operating states and operating parameters of a pneumatic hoist.

Hoists are known in a variety of designs from the state of the art and are used in particular in the industrial sector for the suspended lifting and moving of loads. For this purpose, the load is usually attached to a chain, cable or similar by means of a hook or other attachment and the chain or cable is moved by means of a drive. The drive comprises a motor, possibly a gearbox and other components. The motor is typically driven either electrically or by means of an operating fluid, in particular hydraulically or pneumatically.

In order to be able to assess the current state of the hoists and determine various operating states and operating parameters, it is possible for hoists with an electric motor and an electric control system to have a central control unit that monitors the operating processes, including the control of the motor and the lifted loads, and provides corresponding information about current and past operating states and operating parameters. Due to the components present in the electrically operated hoist, such an evaluation, storage and provision of the operating states and operating parameters is easily possible.

However, hoists operated by means of compressed air or another operating fluid typically have a pneumatic or hydraulic control system and a pneumatic or hydraulic motor, so that it is not easy to evaluate and provide operating states and operating parameters. While such an evaluation can still be carried out relatively easily with a hydraulic hoist, which is connected and operated in a closed hydraulic circuit and typically only has two connections of the motor for the hydraulic fluid, the problem with pneumatic hoists is that one fluid inlet is provided for each direction of rotation of the motor and the motor of the hoist is not operated in a closed pneumatic fluid circuit. Instead, the compressed air used for the drive is typically discharged into the environment through a fluid outlet that is separate from the inlets, so that there is a much greater dependence on the ambient conditions, such as the ambient air pressure or a back pressure at the fluid outlet, which makes reliable evaluation much more difficult. Finally, it is also not easy to store information with a purely fluid-powered hoist, so that information about past operating states and past operating parameters of the fluid-powered hoist is not accessible.

The invention is therefore based on the object of providing a pneumatic hoist and a method for capturing and storing operating states and operating parameters of a pneumatic hoist, which allow operating states and operating parameters of the hoist to be reliably determined with a high degree of accuracy in a structurally simple manner.

According to the invention, the object is solved by a pneumatic hoist according to claim 1 and a method for capturing and storing operating states and operating parameters of a pneumatic hoist according to claim 10. Advantageous further embodiments of the invention are given in the dependent claims.

The pneumatic hoist according to the invention has a pneumatic motor for lifting and lowering a load, a first fluid inlet of the motor for lifting the load, a second fluid inlet of the motor for lowering the load and a fluid outlet exiting the motor, wherein at least one, preferably at least two pressure sensors are arranged in the region of the first and/or the second fluid inlet and at least one further pressure sensor is arranged in the region of the fluid outlet. Furthermore, the pneumatic hoist comprises a data processing unit which is designed to capture the pressure values of the pressure sensors and to calculate operating states and operating parameters of the hoist therefrom. Finally, the pneumatic hoist according to the invention has a load collective storage unit for storing the operating states and operating parameters of the hoist.

The method according to the invention for capturing and storing operating states and operating parameters of a pneumatic hoist with a pneumatic motor for lifting and lowering a load, a first fluid inlet of the motor for lifting the load, a second fluid inlet of the motor for lowering the load and a fluid outlet exiting the motor as well as at least one, preferably at least two pressure sensors which are arranged in the area of the first and/or the second fluid inlet as well as a further pressure sensor which is arranged at the fluid outlet, comprises the steps of capturing the pressure values of the pressure sensors during operation of the hoist by means of a data processing unit, followed by calculating operating states and operating parameters of the hoist by means of the captured pressure values of the pressure sensors, and finally storing the operating states and operating parameters of the hoist by means of a load collective storage.

The inventors have recognized that by means of at least two pressure sensors, one at at least one of the fluid inlets and another at the fluid outlet of the motor, the operating states and operating parameters of a pneumatic hoist can be captured very accurately in a particularly simple manner or the corresponding operating states and operating parameters can be calculated particularly easily on the basis of the pressure values obtained. In addition, storing the operating states and operating parameters in the hoist is particularly advantageous in order to enable economical operation and demand-orientated maintenance in the long term.

A pneumatic hoist is basically a hoist for lifting and lowering loads, in which at least the motor intended for lifting and/or lowering the load is driven by means of the pneumatic operating fluid, in particular by means of compressed air. The hoist is preferably operated exclusively by means of the operating fluid and particularly preferably exclusively by means of compressed air. It is also preferred that the pneumatic hoist does not have an external electrical connection, at least for an electric motor, and/or does not require an external power supply for operation. Furthermore, it is preferred that the pneumatic hoist has a modular design, whereby it is particularly preferred that the pressure sensors and/or the electronic components, in particular the data processing unit and/or the load collective storage, are part of a modular motor unit of the hoist.

In principle, the operating fluid can be any gas, for example air, nitrogen or a gas mixture. The operating fluid is preferably compressed air, whereby compressed ambient air is particularly preferred. However, the compressed air can also have a different chemical composition to the ambient air. The pressure of the compressed air is generally higher than the ambient or normal pressure and is preferably between 1.5 bar and 50 bar, particularly preferably between 2 bar and 30 bar, most preferably between 3 bar and 15 bar and particularly preferably between 4 bar and 10 bar.

The motor of the pneumatic hoist can initially be any gas-powered fluid motor. Preferably, it is an expansion motor and particularly preferably a gas expansion motor. Most preferably, the motor is a pneumatically operated vane motor or a compressed air vane motor. Furthermore, the vane motor is preferably provided for driving the hoist and in particular a chain of the hoist.

According to the invention, the motor has a fluid inlet each for lifting and lowering a load and a fluid outlet. The fluid inlets each lead to or into the pneumatic motor and enable the load to be lifted or lowered by means of the motor when a corresponding operating pressure is applied. During lifting, the operating fluid flows through the inlet for lifting through the motor to the outlet, while during lowering, the operating fluid flows through the inlet for lowering through the motor to the outlet.

Furthermore, the unused inlet can also be used in addition to the outlet of the engine to drain part of the supplied operating fluid. For example, when using a vane motor, the inlet for lowering also vents the compression chamber during lifting and the inlet for lifting also vents the compression chamber of the vane motor during lowering. Alternatively, the outlet of the operating fluid can also take place exclusively through a common outlet channel for lifting and lowering operation. Further preferably, the outlet is essentially only used to discharge the operating fluid away from the engine after the work has been carried out, whereby a silencer is preferably arranged at the outlet in order to keep the noise emission of the engine as low as possible. In addition, the outlet can have an outlet line of any length for discharging the discharged operating fluid away from the location of the hoist. Such an outlet line and/or a silencer and/or a filter and/or the fluid outlet itself can thereby generate a significant back pressure, which is preferably to be taken into account when calculating the operating states and operating parameters of the hoist, in particular by means of a pressure sensor arranged at the outlet.

In each case, the fluid inlet is understood to mean not only the inlet opening of the engine itself, but also the compressed air line directly connected to it and supplying the pressurized operating fluid to the engine. The compressed air line can be designed as any component or assembly and can either be part of the motor or an independent component. In principle, the compressed air line must only be suitable for permanently holding and/or conducting a pressurized, gaseous operating fluid.

The invention is basically based on monitoring the motor operating pressures of the pneumatic hoist by means of at least two pressure sensors and preferably by means of as many pressure sensors as the number of fluid inlets and the fluid outlet(s). In accordance with the invention, one pressure sensor is arranged each in the region of the first and/or the second fluid inlet for this purpose, with at least one further pressure sensor also being arranged at the outlet in accordance with the invention. In addition, however, it is also conceivable to arrange further pressure sensors on other fluid-carrying parts of the hoist.

In principle, a pressure sensor can be any device for capturing the pressure of the operating fluid. Preferably, the detection is quantitative and absolute pressure values are captured particularly preferred. It is particularly preferred that the pressure sensors provide temperature-compensated pressure values. It is also preferred that all pressure sensors of the pneumatic hoist are identical to each other. In order to be able to use the captured pressure values for further calculation of the operating states and operating parameters, the at least two pressure sensors, preferably at least three, particularly preferably all pressure sensors are directly or indirectly connected to the data processing unit, whereby it is particularly preferred that the pressure sensors transmit the pressure data directly to the data processing unit. The operating states and operating parameters can be calculated immediately after the pressure values have been captured. Alternatively, the captured pressure values and/or other sensor values and/or data can also initially be temporarily stored and then subsequently read out, in particular at periodic time intervals and/or on an event-related basis, and used for calculation.

The data processing unit is an electronic device intended for receiving and processing data. Preferably, the data processing unit also enables data to be sent and, particularly preferably, bidirectional communication with an external component. The data processing unit can also be used as a control unit for the pneumatic hoist, in particular for controlling valves, in particular electropneumatic valves, electrical consumers, sensors and/or other computing units.

According to the invention, the load collective storage is provided for storing the calculated and/or measured operating states and operating parameters, whereby permanent storage, in particular also in the event of an interruption in the power supply, is preferably possible by means of the load collective storage. In principle, the load collective storage can be any data storage medium and/or have any data storage medium, which, however, is preferably non-volatile. Furthermore, the load collective storage can be both a part of the data processing unit and an independent unit. Thus, the load collective storage can be both a function of the data processing unit and a stand-alone device. According to the invention, the function of the load collective storage is to store the operating states and operating parameters of the specific hoist at least over a longer period of time and preferably over the entire operating time of the hoist from its first commissioning, so that a complete data set, e.g. on the use and/or load, of the respective hoist is particularly preferably available.

In general, all electronic components, in particular the data processing unit and the load collective storage and possibly other electronic components, can be arranged at any position in the area of the hoist and/or directly on and/or in the hoist. In a preferred embodiment, the electronic components, possibly with the exception of the pressure sensors, are arranged completely in a handheld controller of the hoist, making them easily accessible to a user. Alternatively, it is also conceivable that all electronic components and/or the logic are arranged in the hoist or in the part of the hoist comprising the motor and/or a gearbox and/or the handheld controller has means for data and/or signal output and/or input.

The operating states and operating parameters can be the captured pressure itself, values calculated and/or derived from it and other parameters of the hoist or its operation. The operating states and/or operating parameters can be, in particular, the current load of the hoist, the motor torque, the previous load hours or the operating time and, in particular, the previous full load cycles of the hoist. However, information about the operating times, the lifting and/or lowering speed, the lifting and/or lowering distance, maintenance performed, omitted and/or necessary in the future, the applied operating fluid pressure, the operating temperature and/or temperatures within the hoist, and/or further data on the operation of the hoist can also be operating states and operating parameters within the meaning of the present invention.

In principle, the operating states and operating parameters can be determined and/or calculated in any way. Preferably, the operating states and operating parameters are calculated at least partially using a characteristic diagram determined for the respective hoist type and, in particular, preferably for the respective hoist. The characteristic diagram can be determined externally for the respective hoist and programmed into the data processing unit or can be determined during operation by the data processing unit itself.

In a further preferred embodiment of the pneumatic hoist according to the invention, a pressure sensor is arranged each in the area of the first and second fluid inlet, so that together with the pressure sensor at the fluid outlet, three pressure values can be recorded at any time at the openings of the motor relevant for the operating fluid and thus for operation. Accordingly, this enables a particularly accurate determination or calculation of the operating states and operating parameters of the hoist.

In a further preferred embodiment of the pneumatic hoist according to the invention, the data processing unit is used to evaluate the pressures of the at least two pressure sensors and preferably all three pressure sensors and/or a quantitative evaluation to calculate the operating states and operating parameters. In particular, an evaluation of pressure differences is preferred. In an advantageous manner, the evaluation can not only provide information about the exceeding of defined limit values, but also enables the current operating state and the current operating parameters of the hoist to be captured precisely.

In an equally preferred embodiment of the pneumatic hoist according to the invention, at least one, preferably several and particularly preferably all of the operating states and operating parameters from the group of the current loading or load of the hoist, the speed of lifting and/or lowering, the number of usage cycles and/or the usage time are calculated by means of the data processing unit and/or on the basis of the captured pressure values, in particular the pressure difference and/or the pressure fluctuations. The current loading or the currently suspended load is preferably calculated directly from the pressure difference, as the pressure difference results directly from the suspended load. Preferably, the pressure sensors are at least sufficiently accurate to determine the suspended load down to a deviation of 20%, particularly preferably 10% and most preferably 5%. It is also preferred that the pneumatic hoist has a real-time clock or a real-time clock module in order to be able to capture the exact time and duration of operation.

A pressure evaluation to determine the speed of lifting and/or lowering is preferably carried out on the basis of pressure fluctuations that occur when a motor blade or another motor component moves past at least one of the fluid inlets and/or the fluid outlet. Accordingly, the number of revolutions or the speed of the motor can be determined, whereby the raised and lowered distance and, in particular, the chain stroke or the usage time can also be determined directly. the chain lowering can be calculated. The number of utilization cycles can also be determined accordingly.

In addition, the data processing unit and/or the captured pressure values can also be used to monitor whether the pneumatic hoist is being operated within permissible limits, in particular the maximum load and/or the maximum speed. If an exceedance of one of these variables, in particular an overload, is detected, this can be stored, reported to another data processing unit and/or displayed to the user. In addition, it is also possible to monitor whether there is sufficient fluid pressure to operate the pneumatic hoist.

In order to be able to better assess the load applied to the hoist to date, a preferred embodiment of the pneumatic hoist according to the invention is one in which the total load of the hoist is calculated and/or stored by means of the data processing unit and/or on the basis of the captured pressure values and by means of the load collective storage, wherein preferably a calculation of the theoretical full load hours and/or a calculation based on the full load cycles to date is performed and/or the total load is stored as theoretical full load hours and/or as completed full load cycles. Preferably, the degree of load is determined relative to the full load, in particular the full load intended for the specific hoist, and the actual utilization time is scaled down or corrected to a full load, if necessary taking a correction factor into account.

In particular, by comparing current and past operating states and operating parameters, not only can the current operating state be captured, but also a forecast of the future operating state with a defined and/or constant load on the hoist can be made. Accordingly, a maintenance interval can be determined and the next necessary maintenance time can at least be estimated or even determined. In addition, current error states and irregularities can also be captured by the data processing unit and/or on the basis of the captured pressure values and reported to a user or an external data processing unit as required. Furthermore, necessary or imminently necessary maintenance and/or the need to lubricate or oil a component of the hoist, in particular the motor and/or the chain, can also be reported to a user. Such a message can be output as text, graphically, in particular on a display, and/or optically, in particular by means of an indicator lamp and/or an LED. Finally, it is preferred that activities carried out, such as maintenance, repair or replacement of a component of the hoist, can be reported by a user and then particularly preferably subsequently stored in the hoist, in particular in the load collective storage.

In a preferred embodiment of the pneumatic hoist according to the invention, the load collective storage device has at least one, preferably at least two long-term data storage devices, whereby the data storage of at least some of the operating states and operating parameters is particularly preferably carried out redundantly in at least two long-term data storage devices, whereby the operating states and operating parameters can be stored permanently and, in particular, reliably and tamper-proof.

Furthermore, the pneumatic hoist preferably has a digital communication interface for reading out the operating states and operating parameters on the hoist and/or on the handheld controller. The communication interface is provided at least for reading out and/or transmitting some of the operating states and operating parameters, preferably all of the data from the data processing unit and/or the load collective storage. Both purely one-way communication, i.e. reading out the operating states and operating parameters, and bidirectional and/or interactive communication, in particular with feedback and/or for controlling the data processing unit, are conceivable. However, it is particularly preferable that the load collective storage and/or the operating states and/or operating parameters stored on it can only be accessed in read-only mode and not in write mode, in order to ensure the reliability of the operating states and/or-operating parameters stored on it. The communication interface can also be used to provide information to a user and/or for access by a service technician and/or for connection to an external controller. In addition, a communication interface can also be provided via a program for a computer or a mobile device, in particular a tablet or a cell phone.

In particular, a communication interface to a higher-level control system and/or a central control room is preferred. A communication interface to a PLC controller is also preferred. The communication interface can be of any design, although a standardized design is preferred. Communication can take place via any data cable or any protocol, such as an Ethernet, bus, modem or USB cable, or wirelessly, such as via radio, GSM, WLAN, NFC, RFID, Bluetooth or other protocols.

A preferred embodiment of the method according to the invention for capturing and storing operating states and operating parameters of a pneumatic hoist provides for the operating states to be calculated on the basis of the pressure difference of two pressure sensors. The pressure difference is particularly preferably evaluated by comparing the pressure on the lifting side of the motor and the lowering side of the motor, whereby the current load and/or the number of revolutions of the motor and the lifting or lowering speed of the load can be determined from the pressure difference.

In addition, it is preferred that a third pressure value, in particular from a pressure sensor arranged in the area of the fluid outlet of the motor, is also taken into account when calculating the operating states and operating parameters and is particularly preferred for standardizing or correcting hoist-specific and/or environment-specific factors. Hoist-specific factors can be, for example, power losses due to mechanical friction in components of the hoist, the dead load of the hook and/or the chain, the design or length of a fluid outlet and factors due to the respective design of the hoist and in particular the motor. Environment-specific factors include the ambient temperature, the ambient pressure, the air humidity and also the type and properties of the operating fluid used for operation, in particular compressed air.

In addition, a further development of the method according to the invention for capturing and storing operating states and operating parameters of a pneumatic hoist is preferred, in which a calculation of the motor torque and/or a motor speed is carried out on the basis of the ratio and, particularly preferably, exclusively on the basis of the ratio of the three pressure values of all three pressure sensors.

An embodiment of a pneumatic hoist according to the invention is explained in more detail below with reference to the drawing.

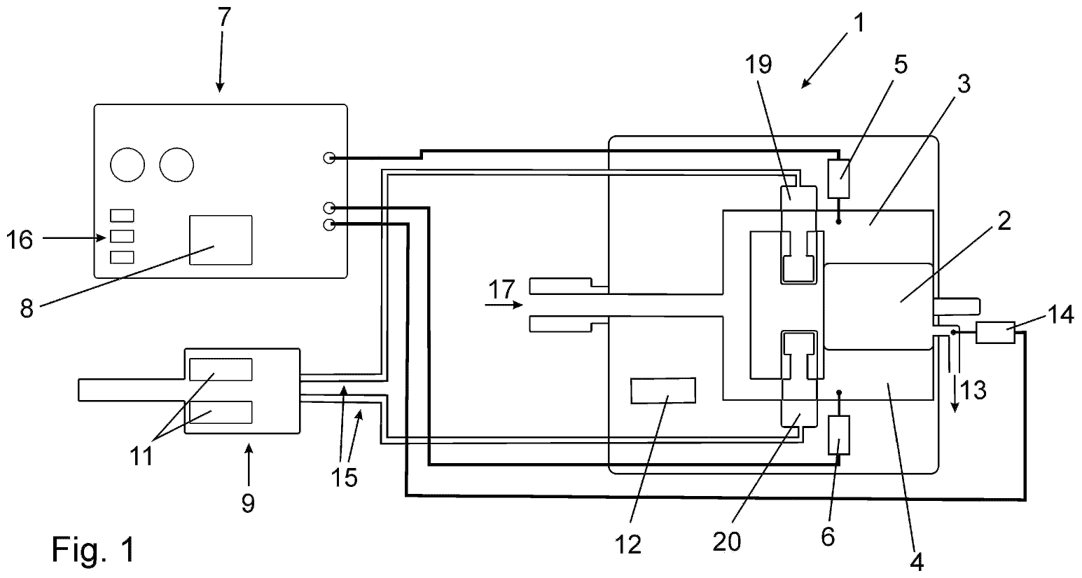

FIG. 1 shows: A schematic view of the structure of a pneumatic hoist with pneumatic control.

A pneumatic hoist 1 shown in FIG. 1 for lifting and lowering loads by means of a hook on a chain is arranged on the ceiling of a hall. The hoist 1 has a pneumatic vane motor 2 as the drive. Accordingly, the hoist 1 is connected to at least one compressed air line at the ceiling of the hall, whereby the compressed air line is connected to a compressed air supply line 17 of the hoist 1. There is no electrical connection, as a pneumatically operated hoist 1 does not usually require a power supply.

In order to be able to lift and lower a load by means of the hoist 1 when a corresponding operating pressure is applied to a compressed air supply line 17, the motor 2 has a fluid inlet 3,4 for lifting and for lowering and a fluid outlet 13. When lifting, the compressed air flows through the first fluid inlet 3 for lifting through the motor 2 to the fluid outlet 13, while when lowering, the compressed air flows through the second fluid inlet 4 for lowering through the motor 2 to the fluid outlet 13. Due to the use of a vane motor 2, the second fluid inlet 4 for lowering also vents a compression chamber of the motor 2 during lifting and the first fluid inlet 3 for lifting vents the compression chamber of the vane motor 2 during lowering. The fluid outlet 13 primarily serves only to discharge the compressed air and has a silencer (not shown) in order to keep the noise emission of the motor 2 as low as possible. The opening and closing of the two fluid inlets 3, 4 is controlled in each case by means of a pneumatic valve 19, 20 arranged in the fluid inlets 3, 4.

In order to be able to determine various operating states and operating parameters, including the load currently being lifted, the lifting or lowering speed, the total usage time to date and the full load cycles performed by the hoist 1 to date, a pressure sensor 5, 6 is arranged in each of the two fluid inlets 3, 4. In addition, another pressure sensor 14 is also arranged at the fluid outlet 13 of the motor 2.

The pressure values determined by the pressure sensors 5, 6, 14 for calculating the operating states and operating parameters are then evaluated in a data processing unit 7 to which the pressure sensors 5, 6, 14 are connected. The calculated operating states and operating parameters are also stored in a non-volatile load collective storage 8, in particular for the addition of the continuously determined operating states and operating parameters, such as the total usage time and the theoretically calculated full load cycles.

For operation by a user, the hoist 1 has a handheld controller 9, which can be used to control the lowering and lifting of a load on the hook of the chain. For this purpose, the handheld controller 9 has two actuation buttons as control elements 11. The handheld controller 9 is connected to the hoist 1 by means of compressed air lines and controls the two valves 19, 20 at the fluid inlets 3, 4 via a pneumatic control line 15 in each case, in particular by means of one of the actuation buttons in each case.

Furthermore, the pneumatic hoist has a display element 12 on a housing, on which the operating states and operating parameters are accessible and on which errors and warnings can be output.

### LIST OF REFERENCE SYMBOLS

1 pneumatic hoist
2 pneumatic motor
3 first fluid inlet
4 second fluid inlet
5 first pressure sensor
6 second pressure sensor
7 data processing unit
8 load collective storage
9 manual control
11 control elements
12 display elements
13 fluid outlet
14 further pressure sensor
15 pneumatic control line
16 communication interface
17 compressed air supply line
19 first valve
20 second valve

1. Pneumatic hoist, with
a pneumatic motor for lifting and lowering a load,
first fluid inlet of the motor for lifting the load, a second fluid inlet of the motor for lowering the load and a fluid outlet exiting the motor,
at least one pressure sensor, which is arranged in the region of the first and/or the second fluid inlet,
at least one further pressure sensor, which is arranged in the area of the fluid outlet,
a data processing unit which is designed to capture the pressure values of the pressure sensors and to calculate operating states and operating parameters of the hoist therefrom, and
a load collective storage for storing the operating states and operating parameters of the hoist.

2. Pneumatic hoist according to claim 1, wherein a respective pressure sensor is provided, which is arranged in the region of the first and the second fluid inlet.

3. Pneumatic hoist according to claim 1, wherein an evaluation of the pressure difference of at least two pressure sensors for calculating the operating states and operating parameters is carried out by the data processing unit.

4. Pneumatic hoist according to claim 1, wherein the operating states and operating parameters of the current load of the hoist, the speed of lifting and lowering, the number of usage cycles and the usage time are calculated by the data processing unit and/or on the basis of the captured pressure values.

5. Pneumatic hoist according to claim 1, wherein the total load of the hoist is calculated and stored by the data processing unit and/or on the basis of the captured pressure values and using the load collective storage, wherein the full load cycles being calculated and the total load being stored as the number of full load cycles.

6. Pneumatic hoist according to claim 1, wherein the degree of wear of the hoist or of a component of the hoist and/or a remaining time until the next maintenance is calculated by the data processing unit and on the basis of the captured pressure values.

7. Pneumatic hoist according to claim 1, wherein the load collective storage has at least two long-term data storages, wherein the data storage of at least some of the operating states and operating parameters takes place redundantly in the at least two long-term data storages.

8. Pneumatic hoist according to claim 1, wherein the pneumatic motor is a vane motor.

9. Pneumatic hoist according to claim 1, including a digital communication interface for reading out the operating states and operating parameters on the hoist and/or on the handheld controller.

10. Method for capturing and storing operating states and operating parameters of a pneumatic hoist with a pneumatic motor for lifting and lowering a load, a first fluid inlet of the motor for lifting the load, a second fluid inlet of the motor for lowering the load and a fluid outlet exiting the motor, at least one pressure sensor, which is arranged in the region of the first and/or the second fluid inlet, and a further pressure sensor, which is arranged at the fluid outlet, having the following steps
capturing the pressure values of the pressure sensors during operation of the hoist by a data processing unit,
calculating operating states and operating parameters of the hoist using the captured pressure values of the pressure sensors,
storing the operating states and operating parameters of the hoist using load collective storage.

11. Method for capturing and storing operating states and operating parameters of a pneumatic hoist according to claim 10, wherein the operating states are calculated on the basis of the pressure difference of at least two pressure sensors.

12. Method for capturing and storing operating states and operating parameters of a pneumatic hoist according to claim 10, wherein the operating states are calculated on the basis of the pressure difference of the two pressure sensors at the two fluid inlets, taking into account the pressure measured by the pressure sensor at the fluid outlet of the motor.
